(19) United States
(12) Patent Application Publication
(10) Pub. No.: US 2003/0195958 A1
(43) Pub. Date: Oct. 16, 2003

(54) Process and system for capture and analysis of HFC based packet data

(75) Inventors: Daniel J. Byron, Marlborough, MA (US); Howard Ngai, Southborough, MA (US); David A. Cardin, Stoneham, MA (US); Milton Fernandes, Marlborough, MA (US)

Correspondence Address: LEFFERT JAY & POLGLAZE, P.A., P.O. BOX 581009, MINNEAPOLIS, MN, 55458-1009, US

(73) Assignee: ADC Broadband Access Systems, Inc.

(21) Appl. No.: 10/122,696

(22) Filed: Apr. 11, 2002

(51) Int. Cl. G06F 15/173

(52) U.S. Cl. 709/224; 714/45

(57) ABSTRACT

A process for selecting for analysis data units from multiple threads of traffic through a single data switch is provided. The process includes capturing all data units of one thread of traffic when said thread is selected by a system administrator, encapsulating data units matching first criteria with identification and forwarding information, and triggering on said captured data units according to second criteria selectable during said process. The process further includes filtering said captured data units according to third criteria selectable during said process and forwarding said filtered data units to a data unit analyzer.

### FIELD OF THE INVENTION

This invention relates generally to computer networks and more particularly to monitoring a network having cable modems.

### BACKGROUND OF THE INVENTION

A cable modem switch is designed to handle many clients. Given the number of clients and the complexity of the overall system, it requires a tool to aid network managers in tracing and determining the cause of problems. This is particularly important where there are a large number of attachment ports that need to be traced and monitored. Network information must be collected and analyzed quickly in order to be useful. A successful monitoring system must also be able to draw on the data stream without adding an undue load and must overcome or avoid data encryption.

It is an object of the present invention to provide a method and apparatus to analyze a cable modem network.

### SUMMARY OF THE INVENTION

The problems of monitoring a cable modem network are solved by the present invention of a protocol analyzer.

Using the protocol analyzer, a system administrator can trace and monitor the traffic on the network from any given node or segment. In addition, statistical and expert analysis can be applied to this data to determine such things as: the general health of the network, overall utilization of the network, course of action for a specific network problem, and intruder detection.

There are three main components in the protocol analyzer, a capture engine, a filter/trigger engine and a display engine. The capture engine collects data and then duplicates, encapsulates, and forwards all packets that meet a basic criteria. The captured data included out-of-band data such as ranging power levels. The capture engine has three parameters which control its operation and can be programmatically set: a flag which operates as an “on/off” switch, a course-level filter and a destination where captured packets are delivered. These controls allow a system administrator the ability to switch between different, physical “cable plants” using a software interface (i.e., a physical tap does not have to be moved between said plants). Further filtering takes place after packets are passed on by the capture engine.

The capture criteria is defined by a course or pre-filter mechanism. The filter/trigger engine collates and filters said data. The display engine then analyzes and displays the data.

The present invention together with the above and other advantages may best be understood from the following detailed description of the embodiments of the invention illustrated in the drawings, wherein:

### BRIEF DESCRIPTION OF THE DRAWINGS

FIG. 1 is a block diagram of the protocol analyzer in a cable network system according to principles of the invention;

FIG. 2 is a flow chart of the data capture process of a receive packet by the protocol analyzer of FIG. 1;

FIG. 3 is a flow chart of the data capture process of a transmit packet by the protocol analyzer of FIG. 1;

FIG. 4 is a diagram of a copied packet with an encapsulation header according to principles of the invention;

FIG. 5 is a block diagram of a rule according to the principles of the present invention;

FIG. 6 is a diagram of the filtering table in the filter/trigger engine of FIG. 1;

FIG. 7 is a diagram of the filter/trigger engine state machine;

FIG. 8 is a flow chart of the operation of the filter/trigger engine according to principles of the invention; and,

FIG. 9 is a flow chart of the matching operation of the filter portion of the filter/trigger engine using the filter table of FIG. 6; and

FIG. 10 is a flow chart of the matching operation of the trigger portion of the filter/trigger engine using the filter table of FIG. 6.

### DETAILED DESCRIPTION OF PREFERRED EMBODIMENTS

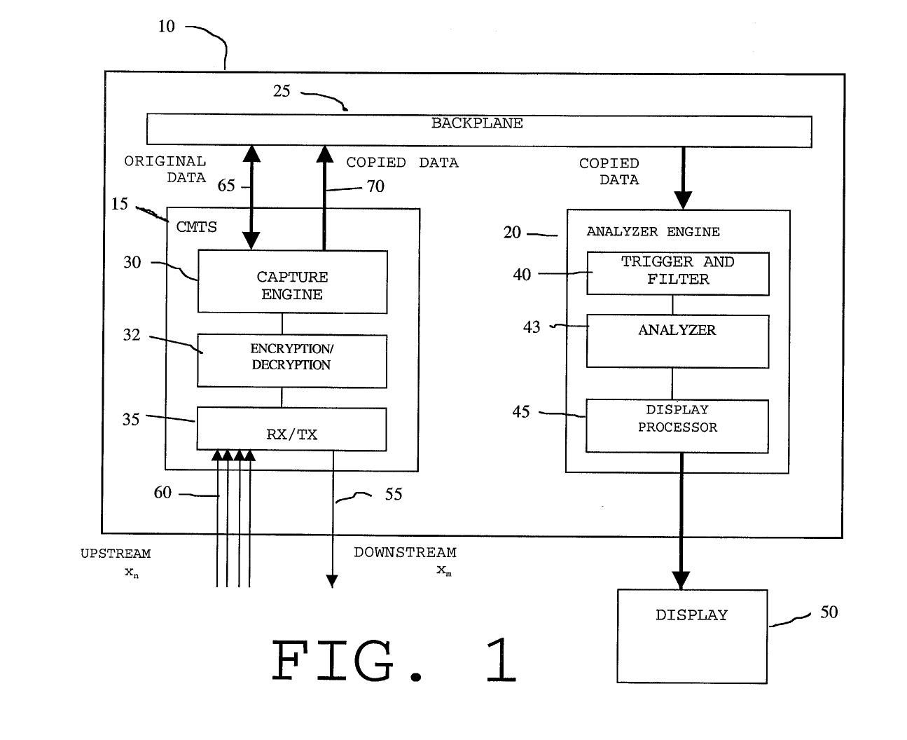

FIG. 1 is a block diagram of a cable modem head end system in a cable modem network implementing a protocol analyzer according to principles of the invention. FIG. 1 shows a chassis 10 having a Cable Modem Termination System (CMTS) card 15 and a analyzer engine card 20 connected by a backplane 25. The CMTS card 15 has a capture engine 30, an encryption/decryption device 32, and a receiver/transmitter 35. The analyzer engine card 20 has a filter/trigger engine 40, an analyzer device 43, and a display unit 50. In alternate embodiments, the display processor 45 may also be external to the chassis.

The chassis 10 takes in signals over the cable modem network. The CMTS card 15 has 4 upstream channels 55 for downloading to cable modem users and 1 downstream channel 60 for uploading data from cable modem users. A chassis may have a plurality of CMTS cards and Analyzer cards. The receiver/transmitter 35 provides a data interface between the CMTS card 15 and the data channels 55, 60. Alternative embodiments of the CMTS card may have more upstream or downstream channels.

The capture engine 30 captures packets, that is, it collects data and the duplicates, encapsulates, and forwards all packets that meet a basic criteria. The criteria is defined by a pre-filter mechanism. The criteria may be all packets on an interface or it may be simply “Protocol X packets from Node Y.” The encryption/decryption engine handles the encryption of data to be transmitted downstream and the decryption of received packets upstream.

The filter/trigger engine 40 in the analyzer engine filters the data arriving from the capture engine 30. The analyzer device 43 performs statistical and heuristical analysis on the data. The display processor then processes the information for display.

Capture Engine

In the present embodiment of invention, the capture engine is a part of the embedded software running on each CMTS card in the chassis. The capture engine captures all data traffic on the receive and transmit paths of the CMTS card. The captured data also includes out-of-band data appropriate to the media, such as ranging power levels and minislot counts for CMTS (capture on an alternate media may include out-of-band data particular to that of the media type). The capture engine captures all data traffic, and for each captured packet, checks a capture flag. The capture engine time-stamps and sequence numbers captured packets. The capture engine then forwards the captured packets to the filter/trigger engine. The capture engine may also pre-filter the data based on some coarse level filter (e.g., “capture only packets from channel X”). The capture engine is implemented in the CMTS card in software.

The capture engine has three parameters which control is operation and can be programmatically set: a flag which operates as an “on/off” switch, a coarse-level filter(s) and a destination where captured packets will be delivered. Control over these values is presented in the display engine. The flag, also called the “capture flag” is set for a card or a port by the system administrator or “user.” The individual packets do not contain the capture flag. This enables the system to set the source of captured data through software and not through a physical tap on a signal line. Although the capture engine offers some level of filtering, the majority of the filtering must be done on the capture engine. The processes of the capture of transmit packets and receive packets are described as follows.

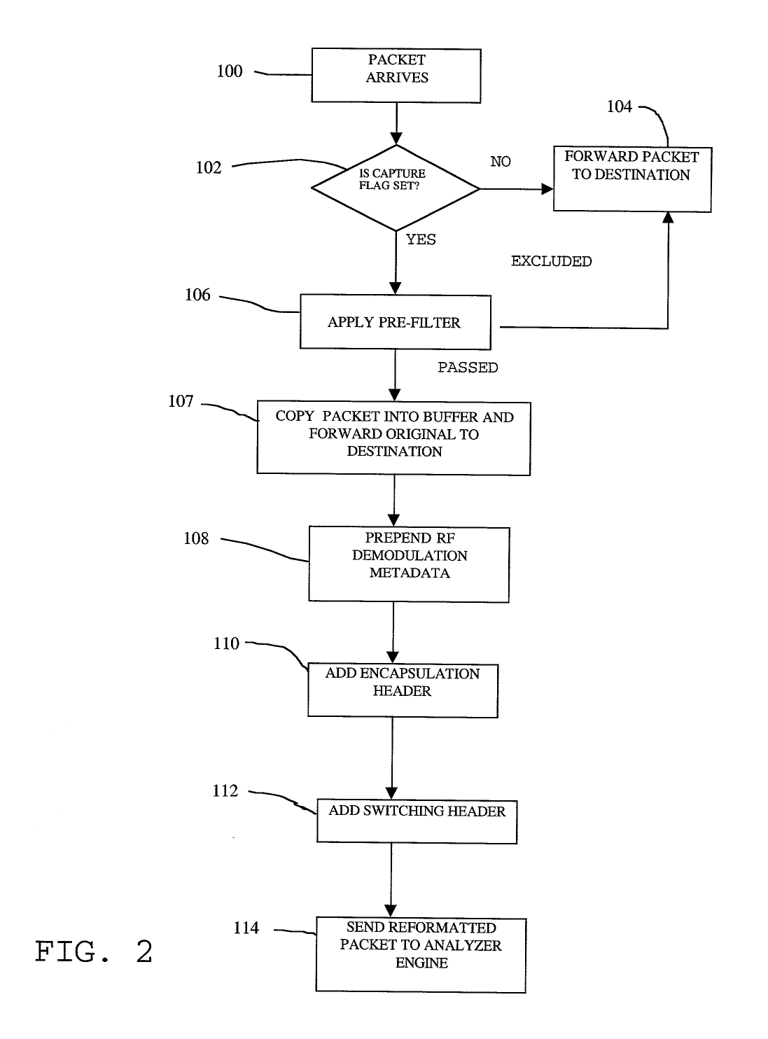

FIG. 2 is a flow chart of the process of capturing a receive packet by the capture engine. A receive packet arrives at the CMTS card, block 100. The capture engine determines if the capture flag is set, block 102. If the capture flag is not set, the packet is forwarded to its destination, block 104. If the capture flag is set, the capture engine applies a pre-filter, block 106. If the packet does not pass through the pre-filter, the packet is forwarded to its destination, block 104. If the packet passes the pre-filter, the packet is copied into a buffer in the capture engine and the original is forwarded to its destination, block 107. The capture engine then prepends RF demodulation out-of-band data, block 108. The out-of-band data is provided by the chipset that received the packet. The out-of-band data is based on measurements made a the time the packet was received. The capture engine then adds an encapsulation header to the copied packet, block 110. The capture engine then adds a switching header, block 112. The reformatted packet is then forwarded to the analyzer engine, block 114.

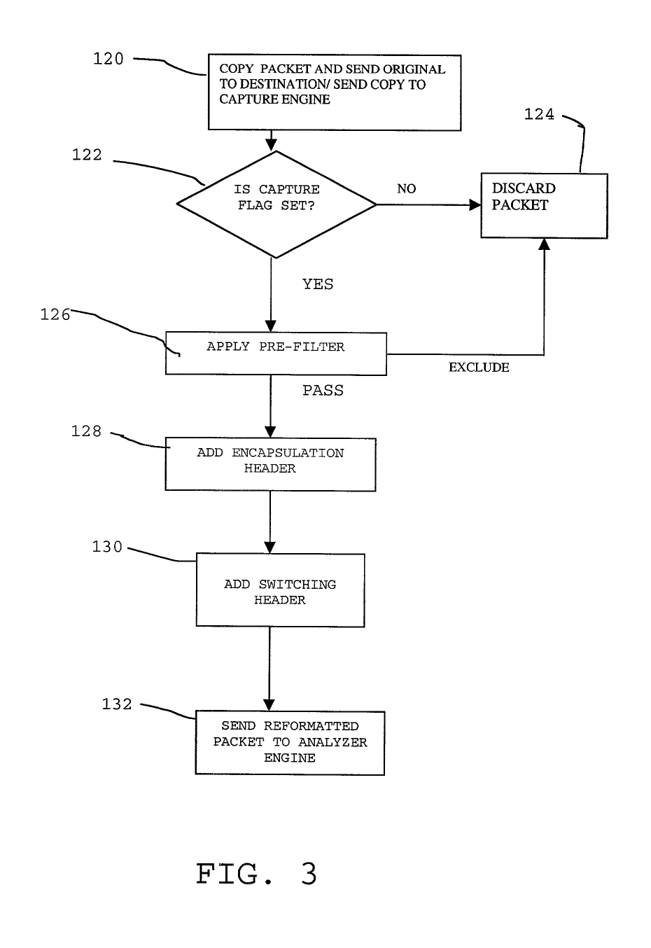

FIG. 3 is a flow chart of the process of capturing a transmit packet by the capture engine. When a transmit packet arrives at the CMTS card, the packet is copied into a buffer and enqueued for transmit on the downstream channel, block 120. After transmission, the packet is forwarded to the capture engine. The capture engine checks to determine whether the capture flag is set, block 122. The capture flag is set on the CMTS card and not on individual data packets. The capture flag is set by the system administrator. If the capture flag is not set, the packet is not captured and the capture process ends for that packet, block 124. If the capture flag is set, the capture engine applies a pre-filter, block 126. If the packet does not pass the pre-filter, the capture process ends for that process, block 124. The capture engine then adds an encapsulation header, block 128, and then a switching header, block 130. The switching header is for transferring the captured data from the CMTS card to the analyzer engine through the backplane. Transfer of data over the backplane is disclosed in a related patent application Ser. No. 09/566,540 filed May 8, 2000 and titled, “System Having a Meshed Backplane and Process of Transferring Data Therethrough.” The capture engine then sends the reformatted packet to the analyzer engine, block 132.

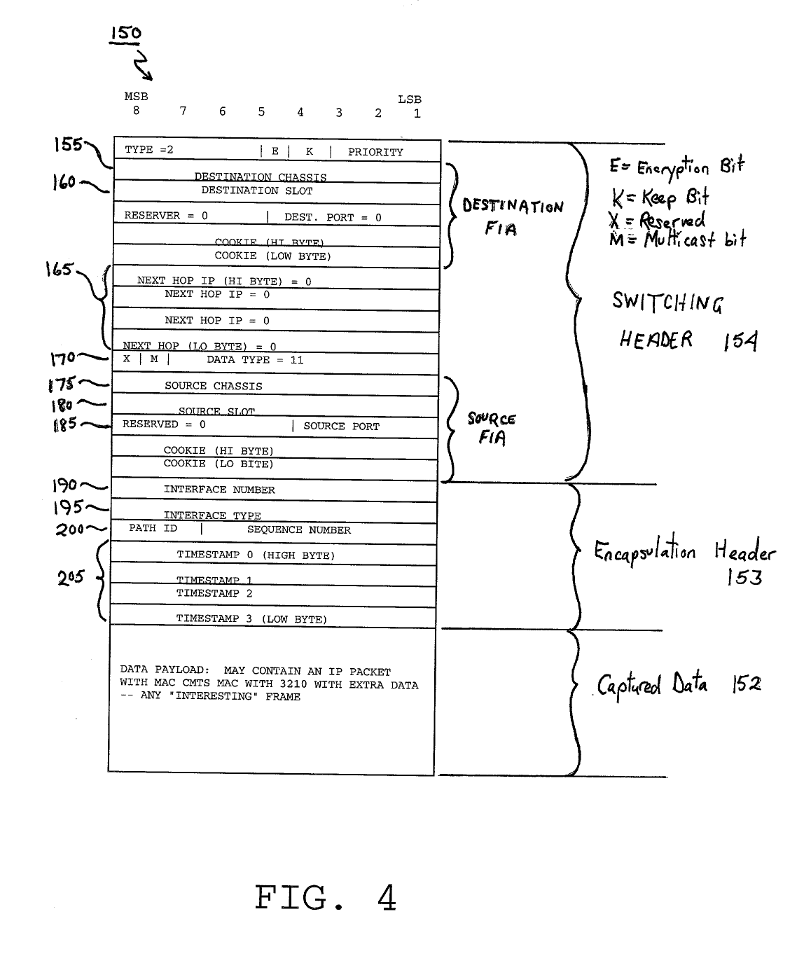

FIG. 4 is a block diagram of the copied packet 150 with the encapsulation header. Captured data 152 is encapsulated with both an encapsulation header 153, and a switching layer header 154 (which contains the destination address for the data). The encapsulation header stores data that indicates which direction the captured data was going, the device on which the data was capture, the time of capture and a sequence number indicating relative order of capture in comparison to other captured packets on the same device. In the present embodiment of the invention, the sequence number and the time stamp are particular to the device. In alternative embodiments of the invention, the sequence number and the time stamp may be chassis-wide.

The elements of the captured packet with the encapsulation header are as follows:

Destination Chassis 155 and Destination Slot 160 are the values assigned during the protocol analyzer startup.

Next Hop IP 165 is not used and can be set to 0.

Data Type 170 is BAS_ENCAPSULATED_PKT (11).

Source Chassis 175, Source Slot 180 and Source Port 185 identify the card (and CPU) that captured this packet.

Interface Number 190 specifies which connection port the data was captured from. Interfaces are numbered sequentially starting from 1; numbering is dependent upon the card type.

Interface Type 195 is a value to help simplify the decode and filter operations. It will have one of the following values:

ETHERNET (1)

SONET (2)

CMTS (3)

Path ID/Sequence Number 200 is a monatonic value that is unique only to this interface number. This may be used by the protocol analyzer to determine that frames were lost in the transfer between capture engine and the decode engine.

Timestamp 205 is used to time stamp when the packet was actually captured.

The capture engine uses the above described encapsulation to deliver the packet to the filter/trigger engine. The encapsulated packets are sent via the backplane 25 to the analyzer engine. If so required, the display engine can use the encapsulation sequence number to note that packets have been lost.

Filter/Trigger Engine

Data is collected and encapsulated with appropriate information and headers by the capture engine and forwarded to the filter/trigger engine. To allow for the greatest level of flexibility, this filtering/triggering process is accomplished using a set of rules arranged in a table. Each filter/trigger rule contains enough information to perform some basic comparison against the packet.

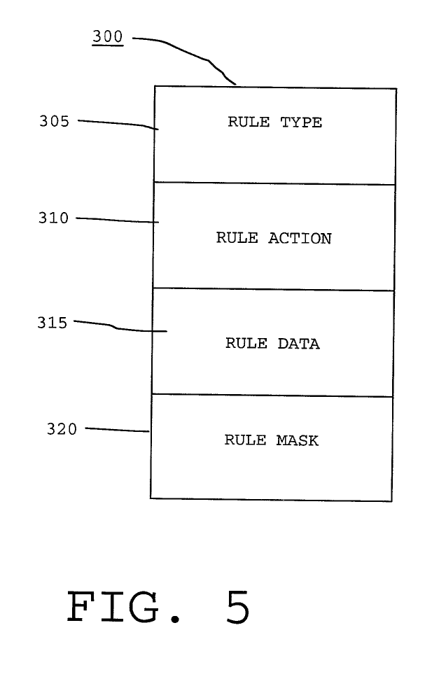

FIG. 5 is a block diagram of a rule 300. Each filter/trigger rule contains a set of parameters:

A rule type 305—which specifies what portion of the packet will be used for the filter (e.g., a rule type of “source IP address” would indicate that the bytes of the packet that form the source address will be matched against the rule data)

A rule action 310—which specifies what to do if the packet matches the rule (e.g., “fail” this match or “proceed” to the next rule; or a “start” or “stop” trigger action_{—}

Rule data 315—data to which the packet data is compared;

Rule mask 320—a value which dictates the portions of the packet data that are valid for this comparison; this allows for bit-level resolution of the data.

Each filter rule can be contained in a 16-byte element where 1 byte is reserved for the rule type, 1 byte is reserved for the rule action, 6 bytes are reserved for the rule data and 8 bytes are reserved for the rule mask (note that the rule mask is oversized only to pad the element out to an even power of 2 bits).

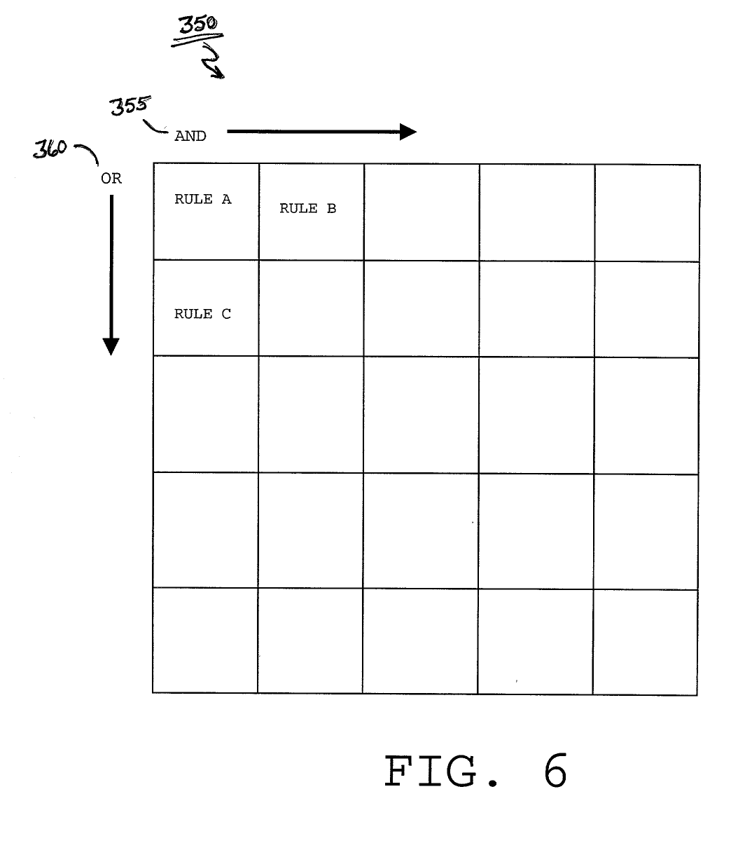

FIG. 6 is a diagram of a filter table 350. In order to build complex filters, a two dimensional filter table is constructed where rule elements in adjacent columns form a logical AND condition 355 and entire rows of the table form logical OR conditions 360. A complex filter expression can be described in such a table by fully expanding the expression such that it is a series of AND expressions connected by logical OR's. To illustrate: (Note: & is logical AND, ‘|’ is logical OR)

| Filter Expression | Expanded Expression | Filter Table |
|---|---|---|
| A & B | A & B | Row 1: {A} {B} |
| A \| B | A \| B | Row 1: {A} |
| | | Row 2: {B} |
| A & (B \| C) | (A & B) \| | Row 1: {A} {B} |
| | (A & C) | Row 2: {A} {C} |
| A \| (B & C) | A \| (B & C) | Row 1: {A} |
| | | Row 2: {B} {C} |
| (A \| B) & (C \| D) | (A & C) \| | Row 1: {A} {C} |
| | (A & D) \| | Row 2: {A} {D} |
| | (B & C) \| | Row 3: {B} {C} |
| | (B & D) | Row 4: {B} {D} |

Though there is an explicit limit to the length of the filter that can be built (i.e., the table dimensions), it is a fairly arbitrary length and reasonably long combinations can be constructed.

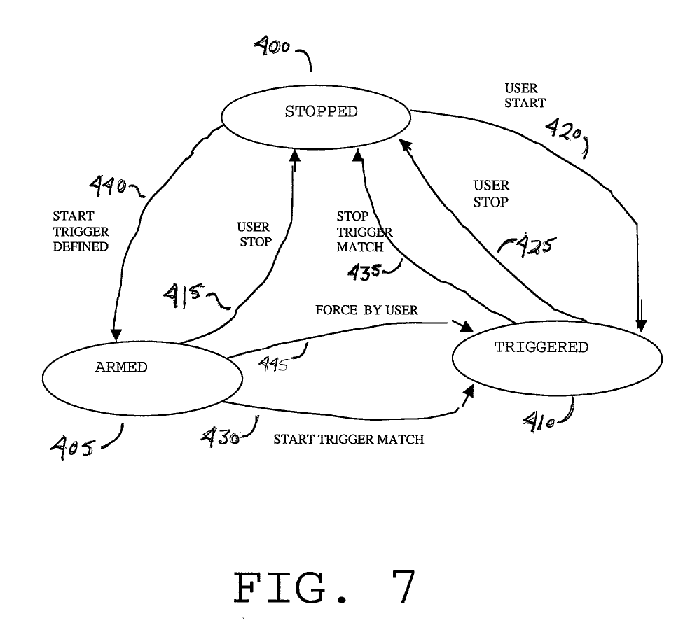

FIG. 7 is a diagram of the filter/trigger engine state machine. The filter/trigger engine can be described as a state machine with three states: STOPPED 400, ARMED 405, or TRIGGERED 410. In the STOPPED state, the filter/trigger engine is stopped and is not operating on packets. In the ARMED state, the filter/trigger engine has a defined trigger condition. In the TRIGGERED state, the filter/trigger engine has received a packet meeting the defined trigger condition and has been triggered.

The system administrator may initiate a transition from the ARMED state to the TRIGGERED state, transition 445, from the ARMED state to the STOPPED state, transition 415, the STOPPED state to the TRIGGERED state 420, and the TRIGGERED state to the STOPPED state 425.

When the filter/trigger engine is in the STOPPED state 400, all capture engine packets are discarded, The filter/trigger engine can be started without defining a “start” trigger, transition 420. In this case, the filter/trigger state moves directly to TRIGGERED, transition 420. When the filter/trigger engine is in the ARMED state 405, packets are compared against the filter table for a match. The system administrator defines the “start” triggers and “arms” the system, transition 440. A match marked as a “start” trigger will cause the filter/trigger engine state to be set to TRIGGERED, transition 430. Any other condition (a match to a “stop” trigger or no match at all) means that the packet is discarded. The engine can be forced from an ARMED to a TRIGGERED state by the user, transition 445. Likewise, the user can force a transition from ARMED to STOPPED, transition 415.

If the filter/trigger state is TRIGGERED, packets are compared against a trigger table to look for a “stop” trigger. If a “stop” trigger is matched, then the filter/trigger state is set to STOPPED, transition 435, and all further packets are discarded. If no match for a “stop” trigger is found, then the packet is further compared against the filter table for a match. Packets that have a match and whose rule is marked as “pass” are sent to the display engine. All other packets are discarded.

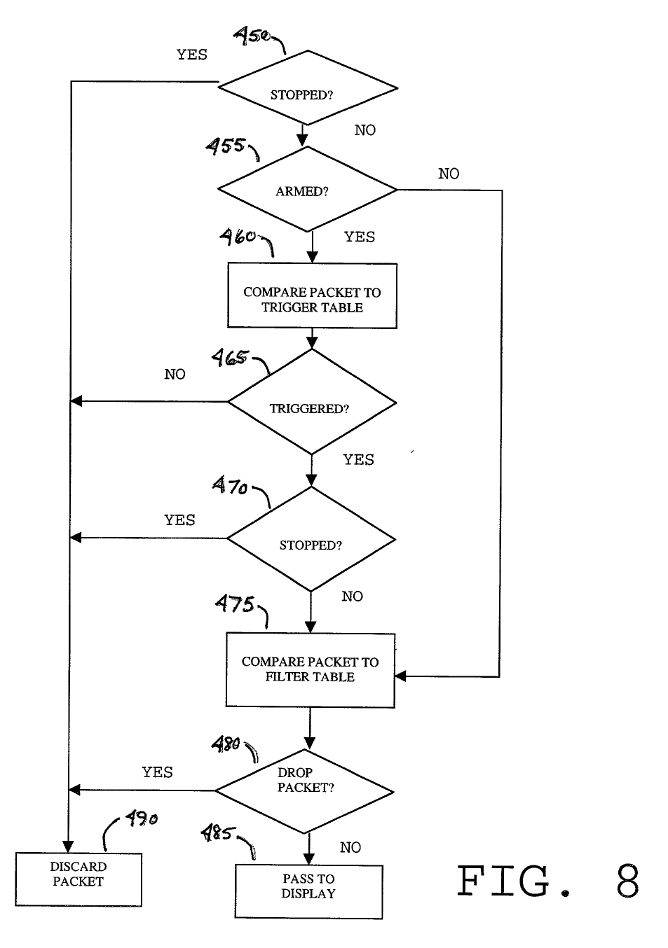

FIG. 8 shows the process of the filter/trigger engine. When a captured packet arrives, the filter/trigger engine first determines if it is in the STOPPED state, block 450. If it is in the STOPPED state, the packet is discarded, block 490. If it is not STOPPED<it determines if it is ARMED, block 455. If it is not ARMED<then the packet is compared to the filter table, block 475. If it is ARMED, the packet is compared to the trigger table, 460. If the engine is not triggered after this comparison, the packet is discarded, block 490. If the engine is triggered after this comparison, the filter/trigger engine again determines whether or not it is stopped, block 470. If it is stopped, the packet is discarded, block 490. If it is not stopped, the packet is compared to the filter table, block 475. From comparison to the filter table, the filter/trigger engine determines whether or not to drop the packet, block 480. If the packet is determined to be dropped, then the packet is discarded, block 490. If the packet is not to be dropped, the packet is passed to the display components for display, block 485.

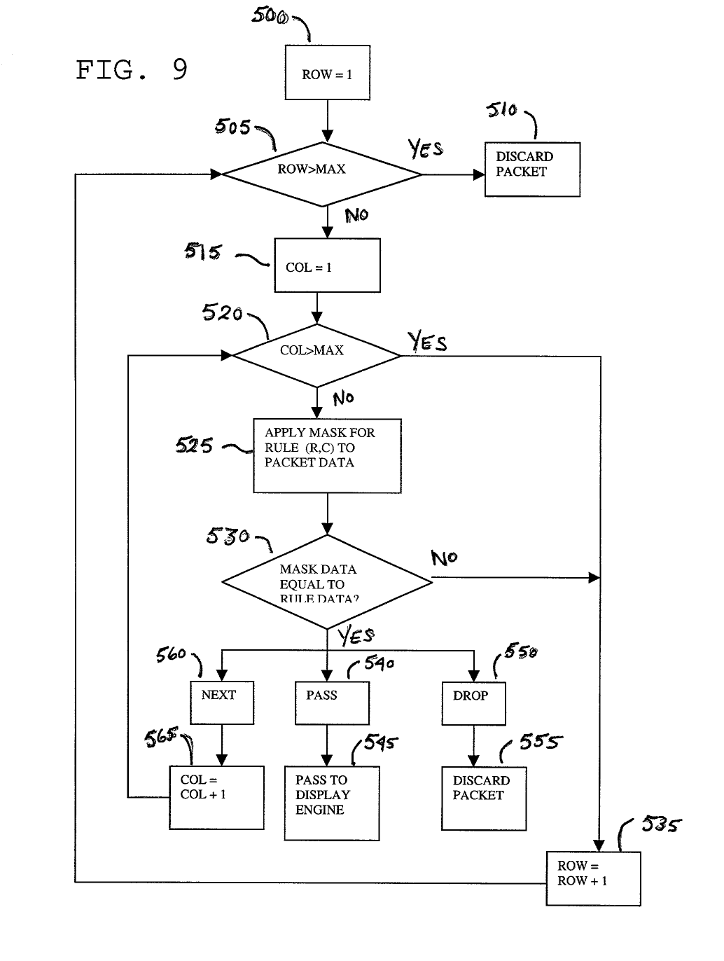

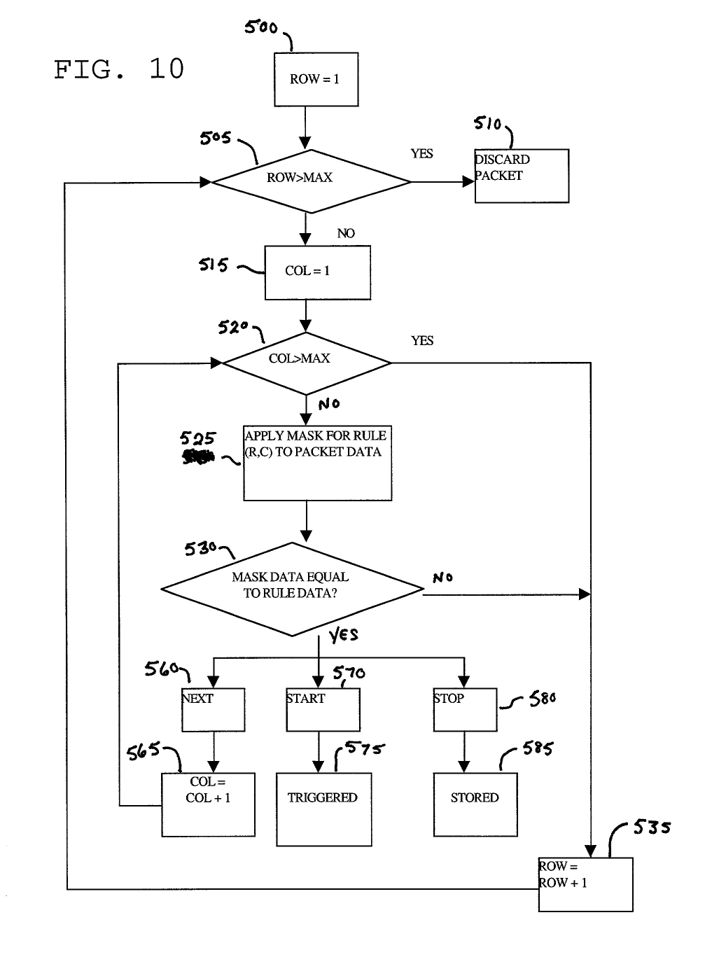

FIGS. 9 and 10 show in detail the method used to compare packets against the filter and trigger rule tables, respectively.

Referring to FIG. 9, the filter engine starts at the first row, block 500. The filter engine then determines if all the rows in the filter table have been examined, block 505. If all the rows have been examined and no match has been found, the packet is discarded, block 510. If the all the rows have not been examined, the filter engine examines the first block in the row, block 515. If the entire row has been examined, block 520, the row number is increased by one, block 535, and the filter engine returns to block 505. If the entries in the row have not been examined, the filter engine applies the mask for the rule at the particular entry being examined, Row R, Column C, to the packet data, block 525. To apply a rule found at row R and column C, the following steps are used:

The rule type in rule (R, C) implicitly defines which bytes in the captured packet will be used for comparison.

The ‘mask’ from the rule (R, C) is applied to the packet data to form ‘masked data’.

The ‘masked data’ is compared against the rule data stored in rule (R, C), block 530.

If the ‘masked data’ and rule data match, the rule action from rule (R, C) specifies the next action to take:

In the filter table:

An action of ‘NEXT’, block 560, means to advance to the next column, (R, C+1), block 565.

An action of ‘PASS’, block 540, means to return a successful match and transfer the packet to the display engine, block 545.

An action of ‘DROP’, block 550, means to discard this packet and begin processing the next, block 555.

If the ‘masked data’ and rule data do not match, the engine skips to the next row (rule (R+1,1)), block 535.

Referring to FIG. 10, the trigger engine starts at the first row, block 500. The trigger engine then determines if all the rows in the trigger table have been examined, block 505. If all the rows have been examined and no match has been found, the packet is discarded, block 510. If the all the rows have not been examined, the trigger engine examines the first block in the row, block 515. If the entire row has been examined, block 520, the row number is increased by one and the trigger engine returns to block 505. If the entries in the row have no been examined, the trigger engine applies the mask for the rule at the particular entry being examined, Row R, Column C, to the packet data, block 525. To apply a rule found at row R and column C, the following steps are used:

The rule type in rule (R, C) implicitly defines which bytes in the captured packet will be used for comparison.

The ‘mark’ from the rule (R, C) is applied to the packet data to form ‘masked data’.

The ‘masked data’ is compared against the rule data stored in rule (R, C), block 530.

If the ‘masked data’ and rule data match, the rule action from rule (R, C) specifies the next action to take:

In the trigger table:

An action of ‘NEXT’ means to advance to the next column (R, C+1).

An action of ‘START’ means to return a successful match and move the filter/trigger state to TRIGGERED.

An action of ‘STOP’ means to move the filter/trigger state to STOPPED.

If the ‘masked data’ and rule data do not match, the engine skips to the next row (rule (R+1,1)), block 535.

Display Engine:

In the present embodiment of the invention a commercial display engine is used and the ability to parse switching headers (BAS headers), internal protocols and CMTS MAC frames are added. In the present embodiment of the invention, the decode engine is the AG Group Etherpeek application.

Decodes

The recognized set of decodes will be substantially added to. EtherPeek defines a “decode language” of sorts that allows for this extensibility. Within this scope the following messages are decoded:

UCD—Upstream Channel Descriptor messages

MAP—Map messages

RNG_REQ/RSP—Ranging messages

REG_REG/RSP/ACK—Registration messages

UCC_REQ/RSP—Upstream Channel Change messages

BPKM_REQ/RSP—Baseline Privacy Key Management messages

DSA_REQ/RSP/ACK—Dynamic Service Addition messages

DSC_REQ/RSP/ACK—Dynamic Service Change messages

DSD_REQ/RSP—Dynamic Service Deletion messages

Fragmented packets—packets which have been split (or fragmented) into smaller units to facilitate transmission

Concatenated packets—packets which have been combined into a lager payload in order to facilitate transmission

Bandwidth Request packets—messages which request additional upstream bandwidth for future transmissions

Encapsulated data—Data units (such as email, web pages, digital video, etc) that are conveyed to and from a users cable modem.

The following messages are recognized but not decoded:

TRI_TCD/TSI—Telco return messages.

It is to be understood that the above-described embodiments are simply illustrative of the principles of the invention. Various and other modifications and changes may be made by those skilled in the art that will embody the principles of the invention and fall within the spirit and scope thereof.

What is claimed is:

1. A process for selecting for analysis data units from multiple threads of traffic through a single data switch, said process comprising:
(a) capturing all data units of one thread of traffic when said thread is selected by a system administrator;
(b) encapsulating data units matching first criteria with identification and forwarding information;
(c) triggering on said captured data units according to second criteria selectable during said process;
(d) filtering said captured data units according to third criteria selectable during said process; and
(e) forwarding said filtered data units to a data unit analyzer.

2. The process of claim 1 wherein capturing all data units of one thread of traffic when said thread is selected by a system administrator is executed by setting a capture flag at a port selected by said system administrator.

3. The process of claim 1 wherein capturing all data units of one thread of traffic when said thread is selected by a system administrator is executed by reading transmit data units twice from a single buffer, once for normal switching and once for capture.

4. The process of claim 1 wherein encapsulating data units matching first criteria with identification and forwarding information further comprises selecting a particular data port as said first criteria.

5. The process of claim 1 wherein said identification information and said forwarding information further comprises a data destination, a capture device, a time of capture, and a sequence number.

6. The process of claim 1 wherein said second criteria further comprises a trigger table having an array of trigger rules.

7. The process of claim 1 wherein said third criteria further comprises a filter table having an array of filter rules.

8. The process of claim 6 wherein each said trigger rule further comprises a trigger rule type, a trigger rule action, trigger rule data, and a trigger rule mask.

9. The process of claim 7 wherein each said filter rule further comprises a filter rule type, a filter rule action, filter rule data, and a filter rule mask.

10. The process of claim 1 wherein said second criteria is provided in a trigger table as types, masks, values, and actions for comparison to information in selected locations of said captured data units.

11. The process of claim 1 wherein said third criteria is provided in a filter table as types, masks, values, and actions for comparison to information in selected locations of said captured data units.

12. A system for analyzing data units from multiple threads of traffic through a data switch, comprising:
(a) means for capturing all data units of one thread of traffic when said thread is selected by a system administrator;
(b) means for encapsulating data units matching first criteria with identification and forwarding information;
(c) means for triggering on said captured data units according to second criteria selectable during data capture;
(d) means for filtering said captured data units according to third criteria selectable during data capture; and
(e) means for forwarding said filtered data units to a data unit analyzer.

13. The system of claim 12 wherein said means for capturing further comprises a means for setting a capture flag at a port selected by said system administrator, said capture flag to signal that data of a particular thread is to be captured.

14. The system of claim 12 wherein said means for capturing further comprises means for reading transmit data units twice from a single buffer, once for normal switching and once for capture.

15. The system of claim 12 further comprising means for selecting a particular data port as said first criteria.

16. The system of claim 12 wherein said second criteria further comprises a trigger table having an array of trigger rules.

17. The system of claim 12 wherein said third criteria further comprises a filter table having an array of filter rules.

18. The system of claim 12 wherein said identification information and said forwarding information further comprises a data destination, a capture device, a time of capture, and a sequence number.

19. A system for analyzing data units from multiple threads of traffic through a data switch, comprising:
a capture engine having a capture switch mechanism, and a preliminary filter, and
an analyzer having a state machine, a filter mechanism and a trigger mechanism,
whereby said capture engine sets said capture switch mechanism to capture data packets and filter said packets with said preliminary filter,
said analyzer engine further filtering said data packets according to the state of the state machine and in response to said filter mechanism and said trigger mechanism.
